(19) United States
(12) Patent Application Publication
(10) Pub. No.: US 2018/0075997 A1
(43) Pub. Date: Mar. 15, 2018

(54) X-RAY TUBE AND A CONTROLLER THEREOF

(71) Applicant: Nanox Imaging PLC, Gibraltar (GI)

(72) Inventors: Hidenori KENMOTSU, TOKYO (JP); Hitoshi MASUYA, CHIBA (JP)

(73) Assignee: Nanox Imaging PLC, Gibraltar (GI)

(21) Appl. No.: 15/472,549

(22) Filed: Mar. 29, 2017

Related U.S. Application Data
(60) Provisional application No. 62/316,365, filed on Mar. 31, 2016.

(51) Int. Cl. H01J 35/06; H01J 35/08; H01J 35/14; H01J 35/16

(52) U.S. Cl. CPC H01J 35/06; H01J 35/08; H01J 2235/068; H01J 35/16; H01J 2235/066; H01J 35/14

(57) ABSTRACT

An X-ray tube comprises a vacuum vessel; a cathode and an anode fixedly disposed inside the vacuum vessel; and a rotary mechanism that rotates the vacuum vessel. The cathode is disposed on the circumference with the rotary shaft of the rotary mechanism as its center and includes a plurality of cathode parts that can individually be turned ON/OFF. The anode includes parts opposite to the plurality of cathode parts, respectively.

### FIELD OF THE INVENTION

The present invention relates to an X-ray tube and a controller therefor.

### DESCRIPTION OF RELATED ART

X-ray tubes used in fluoroscopic photographing for medical or other purposes has a cathode and an anode opposite to the cathode in a vacuum vessel and generates an X-ray from an electron colliding portion on the anode by that cathode electrons collide with the anode. Such X-ray tubes are required to generate X-ray having energy and dose sufficiently high enough to transmit a photogenic subject and to have a sufficiently small X-ray generation portion so as to ensure fineness of a fluoroscopic image necessary for the applications. Thus, energy per unit area produced by cathode electrons at the X-ray generation portion, i.e., electron colliding portion may become large enough to melt the anode which is generally made of metal such as tungsten in a moment, which may break the X-ray tube.

As one of methods for solving the above problem, the following method can be considered. That is, as illustrated in FIG. 6, in an X-ray tube 100, an anode 101 is rotated at high speed to thereby temporally and spatially avoid energy concentration at a focal point 104 with which an electron beam 103 from a cathode 102 collides (refer to, e.g., U.S. Pat. No. 2,242,182). There have been other various inventions relating to such a rotary type anode structure to satisfy securing of a vacuum property and conductivity/heat radiation property and lubricity for high-speed rotation at the same time (refer to, e.g., U.S. Pat. No. 5,150,398 and U.S. Pat. No. 6,292,538).

### SUMMARY

Among these inventions, there is one, like an X-ray tube 200 illustrated in FIG. 7, in which a vacuum vessel 205 itself to which an anode 201 is fixed is rotated to fix the absolute position of a colliding portion (focal point 204) of an electron beam 203 from a cathode 202 on the anode 201 to thereby improve a vacuum holding property/heat radiation property and to eliminate measures for the rotation lubricity. However, in the configuration of FIG. 7, the cathode 202 is fixed to the center of the rotary shaft of the vacuum vessel 205, so that it is necessary to provide a strong magnetic deflection coil 206 outside the rotating vacuum vessel 205 in order to curve the electron beam 203 emitted from the cathode 202 toward the circumference of the anode 201, which may disadvantageously complicate and enlarge the structure. Further, it is difficult to maintain a correct X-ray generation position.

The object of the present invention is to provide an X-ray tube and a controller therefor capable of solving the above problems.

An X-ray tube according to the present invention includes: a vacuum vessel; a cathode and an anode fixedly disposed inside the vacuum vessel; and a rotary mechanism that rotates the vacuum vessel. The cathode is disposed on the circumference with the rotary shaft of the rotary mechanism as its center and includes a plurality of cathode parts that can individually be turned ON/OFF. The anode includes parts opposite to the plurality of cathode parts, respectively.

A controller according to the present invention is a controller that controls an X-ray tube. The X-ray tube includes: a vacuum vessel; a cathode and an anode fixedly disposed inside the vacuum vessel; and a rotary mechanism that rotates the vacuum vessel. The cathode is disposed on the circumference with the rotary shaft of the rotary mechanism as its center and includes a plurality of cathode parts that can individually be turned ON/OFF. The anode includes parts opposite to the plurality of cathode parts, respectively. The controller intermittently or continuously selects one of the plurality of cathode parts that generates an electron beam in a switching manner in sync with the rotation of the rotary mechanism.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a perspective view schematically illustrating a part of an X-ray tube 1 according to a first embodiment of the present invention;

FIG. 2 is a view illustrating the X-ray tube 1 and a controller 10 according to the first embodiment of the present invention;

FIG. 3A is a view illustrating a cathode switching circuit 10a according to the first embodiment of the present invention;

FIG. 3B is a view illustrating a contact mechanism 10b according to the first embodiment of the present invention;

FIG. 4 is a view illustrating a relationship according to the first embodiment of the present invention between the rotation angle of the vacuum vessel 5 and the cathode part 2a that emits the electron beam E;

FIG. 5 is a perspective view schematically illustrating a part of the X-ray tube 1 according to a second embodiment;

FIG. 6 is a diagram indicating an X-ray tube 100 according to a related art of the present invention; and

FIG. 7 is a diagram indicating an X-ray tube 200 according to a related art of the present invention.

### DETAILED DESCRIPTION OF THE EMBODIMENTS

Preferred embodiments of the present invention will be explained below in detail with reference to the accompanying drawings.

In the present invention, both the anode and cathode are fixed in the X-ray tube, and the X-ray tube itself is rotated. In this configuration, the cathode is continuously arranged, or the plurality of cathode parts are arranged on the circumference so as to correspond an X-ray generating circumference on the anode surface, and the electron beam generation portion of the cathode is switched according to the rotation of the X-ray tube, thereby eliminating the need to provide an electron beam deflection mechanism. It is necessary to switch the electron beam generation portion according to high-speed rotation of the X-ray tube/anode, so that it is preferable to use, not a conventional filament, but a cold cathode as the cathode but not limited thereto.

In other words, the present invention provides a structure of X-ray tube that allows the fixed type anode structure that can be adapted conventionally only for the generation of an X-ray with low energy, low dose, and large-sized generation focal point to be used for the generation of an X-ray with high energy, high dose, and small-sized generation focal point that was realized only by the rotary type anode structure and is characterized by the cathode array disposed on the circumference and sequentially/continuously switching the electron generation portion thereof.

Thus, a mechanically movable part is completely eliminated from the inside of the high-output X-ray tube, and there is no magnetic field mechanism that deflects electrons near the X-ray tube, making it possible to obtain a high-output X-ray from a simple structure.

Hereinafter, first and second embodiments of the present invention will be described successively.

### First Embodiment

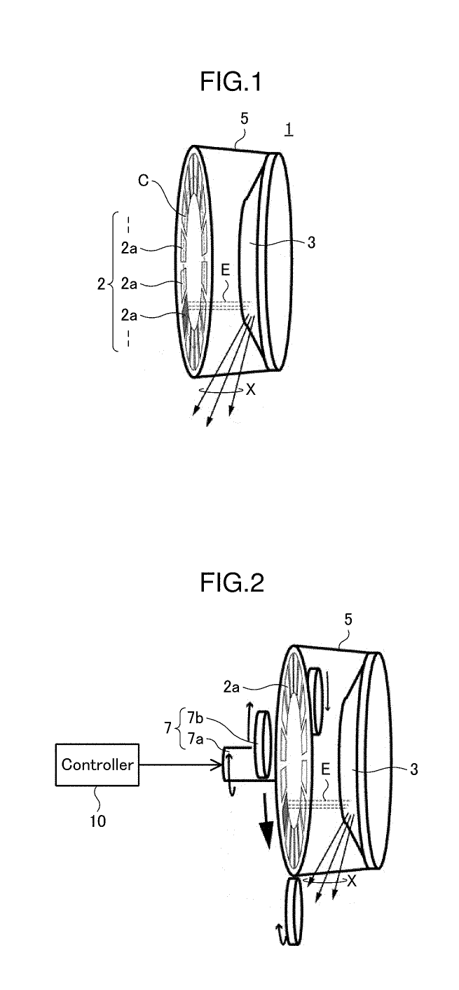

FIG. 1 is a perspective view schematically illustrating a part of an X-ray tube 1 according to a first embodiment of the present invention, and FIG. 2 is a view illustrating the X-ray tube 1 and a controller 10 according to the first embodiment. As illustrated in FIGS. 1 and 2, the X-ray tube 1 according to the first embodiment of the present invention includes a cathode 2, an anode 3, a vacuum vessel 5, and a rotary mechanism 7.

The cathode 2 is constituted of a plurality of cathode parts 2a. The plurality of cathode parts 2a are configured as a plurality of parts which are different one another and disposed at equal intervals on a circumference C with the rotary shaft of the rotary mechanism 7 as its center. Further, the cathode parts 2a can individually be turned ON/OFF by the controller 10. A case where a certain cathode part 2a is ON means a state where a voltage having a predetermined value is applied to the cathode part 2a by the controller 10. The cathode part 2a which is turned ON by the voltage application emits an electron beam E toward the anode 3.

The cathode 2 may be configured as a single cathode array. In this case, the plurality of cathode parts 2a may be mutually different parts of the single cathode array.

The anode 3 is a single disk-shaped member disposed so as to be opposed to the cathode 2. The anode 3 and circumference C have a common center axis. When the electron beam E is emitted from any of the cathode parts 2a, it collides with the corresponding part of the anode 3, and an X-ray X is generated there.

The vacuum vessel 5 is a substantially cylindrical vessel having a structure capable of keeping the pressure therein lower than the surrounding atmospheric pressure. The cathode 2 and anode 3 are both fixedly disposed inside the vacuum vessel 5. More specifically, the cathode 2 is fixed to the upper base of the vacuum vessel 5 and the anode 3 to the bottom base.

The rotary mechanism 7 is a mechanism rotating the vacuum vessel 5 and includes, e.g., a shaft 7a and/or a plurality of friction wheels 7b as illustrated in FIG. 2. The friction wheels 7b are disposed in contact with the side surface of the vacuum vessel 5. When the controller 10 rotates the shaft 7a, the friction wheels 7b rotates interlocking with the rotation, whereby the vacuum vessel 5 is rotated by friction between the friction wheels 7b and the side surface of the vacuum vessel 5. At the same time, the cathode 2 and anode 3 fixedly disposed in the vacuum vessel 5 rotate. The thus configured rotary mechanism 7 does not require securing of a vacuum property, conductivity, and heat radiation property and thus has a far simpler structure than the above-mentioned rotary anode type rotary mechanism.

In addition to the function of rotating the vacuum vessel 5 by means of the rotary mechanism 7 as described above, the controller 10 also has a function of intermittently or continuously selecting one of the plurality of cathode parts 2a that generates the electron beam E in a switching manner in sync with the rotation of the rotary mechanism 7. Hereinafter, this function will be described with two examples. In the following description, the position of each of the cathode 2 and anode 3 is referred to as “absolute position”, which means the position as viewed from a coordinate system that is not rotated together with the vacuum vessel 5.

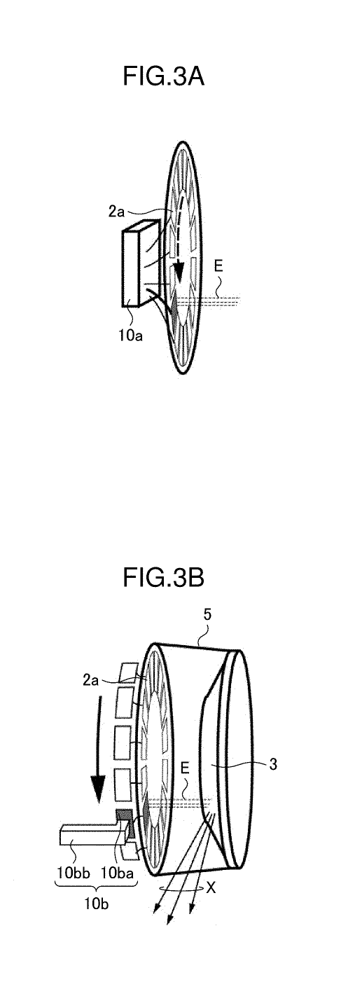

FIG. 3A is a view illustrating a cathode switching circuit 10a included in the controller 10 having an electron beam generation function according to the first example. The cathode switching circuit 10a is configured to be rotated together with the vacuum vessel 5 and connected to the plurality of cathode parts 2a through wirings. Although not illustrated, the cathode switching circuit 10a includes therein a switching circuit for setting one of the wirings connected to the respective cathode parts 2a in a connection state and the remaining wirings in a disconnection state.

The controller 10 according to the first example controls the cathode switching circuit 10a when rotating the vacuum vessel 5 so that the electron beam E is emitted from one of the plurality of cathode parts 2 that is located at a predetermined absolute position. Specifically, the controller 10 controls the cathode switching circuit 10a so as to set the wiring connected to the cathode part 2 located at the predetermined absolute position in a connection state and set the wirings connected to the remaining cathode parts 2 in a disconnection state and then applies a voltage to the cathode 2 via the cathode switching circuit 10a. As a result, the electron beam E is emitted from only the cathode part 2 located at the predetermined absolute position. This allows the X-ray tube 1 to always generate the X-ray X from a fixed absolute position.

FIG. 3B is a view illustrating a contact mechanism 10b included in the controller 10 having an electron beam generation function according to the second example. As illustrated in FIG. 3B, the contact mechanism 10b includes a plurality of terminals 10ba fixed to the plurality of cathode parts 2a respectively and a fixed brush 10bb which is not rotated together with the vacuum vessel 5. The terminals 10ba are electrically connected to their corresponding cathode parts 2a. The fixed brush 10bb is electrically connected to one of the plurality of terminals 10ba that is located at the absolute position.

In this second example, the fixed brush 10bb is always electrically connected to one of the plurality of terminals 10ba that is located at the predetermined absolute position even when the vacuum vessel 5 is rotated under the control of the controller 10. Thus, the controller according to this second example may simply apply a voltage to the fixed brush 10bb. As a result, the electron beam E is emitted from only the cathode part 2 located at the predetermined absolute position. This allows the X-ray tube 1 to always generate the X-ray X from a fixed absolute position.

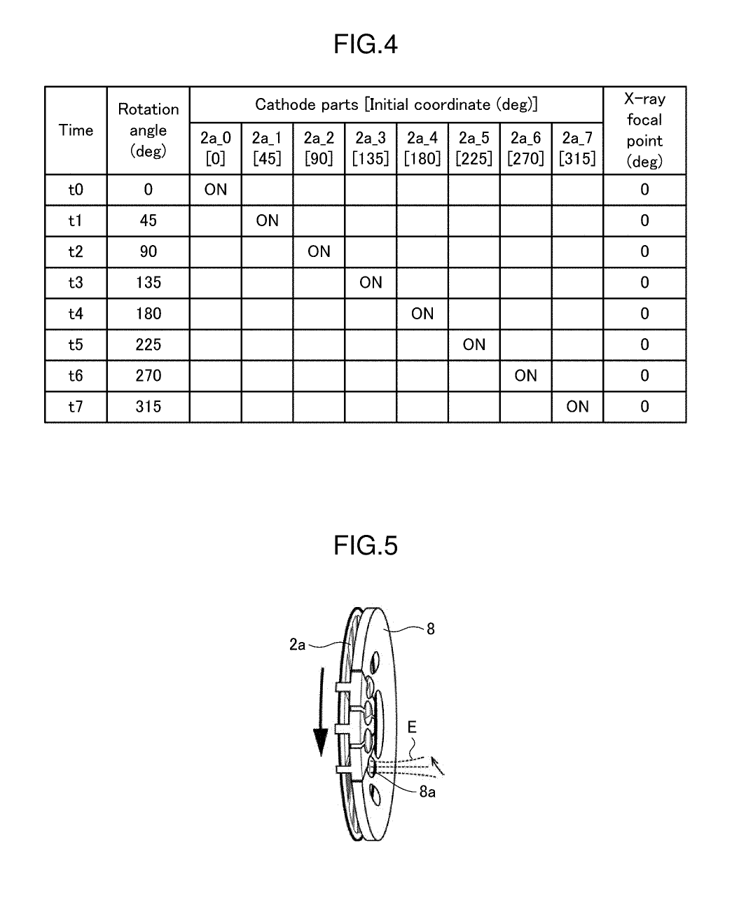

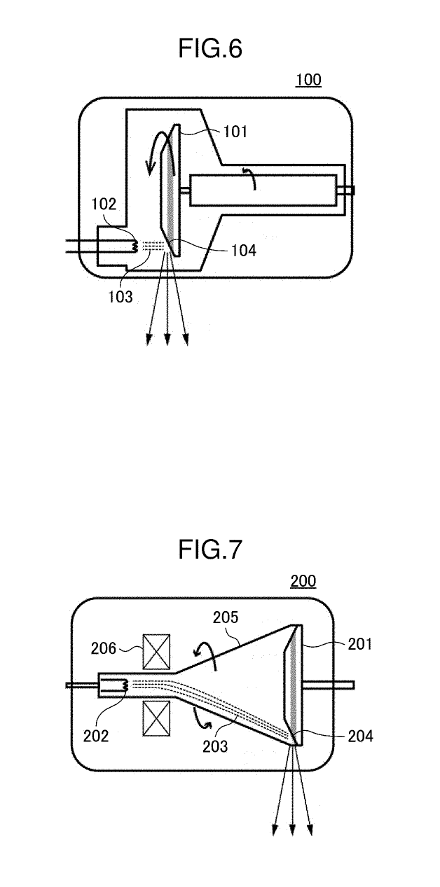

FIG. 4 is a view illustrating the relationship between the rotation angle of the vacuum vessel 5 and the cathode part 2a that emits the electron beam E. Hereinafter, with reference to FIG. 4, the control performed by the controller 10 will be described more in detail.

FIG. 4 illustrates an example in which the cathode 2 is constituted of eight cathode parts 2a_0 to 2a_7. These cathode parts 2a_0 to 2a_7 are arranged at a pitch of 45° along the circumference C illustrated in FIG. 1. The angle illustrated as the initial coordinate in FIG. 4 indicates the absolute position and, as illustrated in FIG. 4, the absolute positions of the respective cathode parts 2a_k (k=0 to 7) in the initial state (rotation angle=0°) are each 45 k°. Thus, the absolute positions of the cathode parts 2a_k when the vacuum vessel 5 is rotated by 45 k° from the initial position can be set to 0° irrespective of the value of k.

The controller 10 makes the cathode parts 2a_k generate the electron beam E in the way described above at times tk at which the vacuum vessel 5 is rotated by 45 k° from the initial state. Since the absolute positions of the cathode parts 2a_k at the times tk are set to 0° irrespective of the value of k as described above, the electron beam E is always emitted from the same absolute position (=0°). Accordingly, the position (X-ray focal point) at which the electron beam E collides with the anode 3 is always 0°. Thus, according to the control performed by the controller 10 illustrated in FIG. 4, the X-ray X can always be generated from a fixed position even in the configuration where the anode 3 is not rotated relative to the vacuum vessel 5.

As described above, according to the X-ray tube 1 and the controller 10 of the present embodiment, the X-ray X can always be generated from a fixed position even in the configuration where the anode 3 is not rotated relative to the vacuum vessel 5. This prevents electronic energy from concentrating on a fixed position of the anode 3, so that effects equivalent to those in the rotary type anode structure can be obtained even in the configuration where the anode 3 is not rotated relative to the vacuum vessel 5.

### Second Embodiment

FIG. 5 is a perspective view schematically illustrating a part of the X-ray tube 1 according to a second embodiment. Although not illustrated in FIG. 5, like the X-ray tube 1 of the first embodiment, the X-ray tube 1 according to the second embodiment includes the vacuum vessel 5, anode 3, and rotary mechanism 7. The X-ray tube 1 according to the present embodiment differs from the X-ray tube 1 according to the first embodiment in that an electrostatic deflection mechanism 8 is additionally provided. Hereinafter, description will be made focusing differences from the first embodiment with the same reference numerals given to the same elements as in the first embodiment.

The electrostatic deflection mechanism 8 is a doughnut-shaped member disposed between the cathode 2 and the anode 3 and is fixed in the vacuum vessel 5 through the cathode 2. The electrostatic deflection mechanism 8 has a plurality of openings 8a one-to-one corresponding to the plurality of cathode parts 2a apart from a center opening. The electron beam E emitted from each cathode part 2a passes through the corresponding opening 8a and collides with the anode 3. With the configuration where the electron beam E emitted from each cathode part 2a passes through the corresponding opening 8a, the electrostatic deflection mechanism 8 plays a role of controlling the focal diameter of the electron beam E generated by the cathode part 2a to a fixed value as well as a role of controlling the path of the electron beam E so that the electron beam E collides with a specific position (e.g., the position corresponding to the absolute angle 0° in the example of FIG. 4) on the anode 3. That is, the electrostatic deflection mechanism 8 plays a role of canceling the rotations of the vacuum vessel 5 and anode 3 to efficiently disperse concentration of electronic energy on the anode 3 by sequentially repeating deflection of the electron beam E in a short range.

As described above, according to the X-ray tube 1 of the present embodiment, the electrostatic deflection mechanism 8 that controls the path of the electron beam E so that the electron beam E collides with a specific position on the anode 3 is provided between the cathode 2 and the anode 3, thereby allowing the electron beam E to always collide with a specific a position on the anode 3.

While the preferred embodiments of the present invention have been described, the present invention is not limited to the above embodiments but may be variously modified within the scope thereof.

What is claimed is:

1. An X-ray tube comprising:
a vacuum vessel;
a cathode and an anode fixedly disposed inside the vacuum vessel; and
a rotary mechanism that rotates the vacuum vessel,
the cathode being disposed on the circumference with the rotary shaft of the rotary mechanism as its center and including a plurality of cathode parts that can individually be turned ON/OFF,
the anode including parts opposite to the plurality of cathode parts, respectively.

2. The X-ray tube according to claim 1, wherein
the anode is configured as a single disk-shaped member opposite to the cathode.

3. The X-ray tube according to claim 1, wherein
the plurality of cathode parts are configured as mutually different members.

4. The X-ray tube according to claim 1, wherein
the cathode is configured as a single cathode array, and
the plurality of cathode parts are mutually different parts of the single cathode array.

5. The X-ray tube according to claim 1, further comprising an electrostatic deflection mechanism disposed between the cathode and the anode, wherein
the electrostatic deflection mechanism controls the path of an electron beam so that the electron beam generated by one of the plurality of cathode parts that is in a turned ON state collides with a specific position on the anode.

6. A controller which controls an X-ray tube,
the X-ray tube comprising:
a vacuum vessel;
a cathode and an anode fixedly disposed inside the vacuum vessel; and
a rotary mechanism that rotates the vacuum vessel,
the cathode being disposed on the circumference with the rotary shaft of the rotary mechanism as its center and including a plurality of cathode parts that can individually be turned ON/OFF,
the anode including parts opposite to the plurality of cathode parts, respectively, wherein
the controller intermittently or continuously selects one of the plurality of cathode parts that generates an electron in a switching manner in sync with the rotation of the rotary mechanism.
